(19) United States
(12) Patent Application Publication
(10) Pub. No.: US 2016/0377763 A1
(43) Pub. Date: Dec. 29, 2016

(54) Multifunction Snowpack Measurement Tool

(71) Applicant: AvaTech, Inc., Park City, UT (US)

(72) Inventors: James Loren Christian, Park City, UT (US); Andrew Stockton Bennett, Eugene, OR (US); Garrett Marshall Harmsen, Englewood, CO (US); David Hoffman, Park City, UT (US); Richard Kirby, Heber City, UT (US); Thomas Laakso, Park City, UT (US); Brint Markle, Park City, UT (US); Joseph J. Trovato, Park City, UT (US)

(21) Appl. No.: 15/189,877

(22) Filed: Jun. 22, 2016

Related U.S. Application Data
(60) Provisional application No. 62/183,785, filed on Jun. 24, 2015.

(51) Int. Cl. G01W 1/14; G01N 3/42; G01N 3/54; G01B 7/26

(52) U.S. Cl. CPC G01W 1/14; G01B 7/26; G01N 3/42; G01N 3/54

(57) ABSTRACT

The present disclosure is directed at a snowpack measurement device that is configurable between a skiing configuration, in which it can be used as a ski pole, and a snowpack measurement configuration, in which it can be used as a probe to measure one or more characteristics of a snowpack. In some embodiments, the device can wirelessly transmit snowpack measurement results, for example, to a user's mobile device. The device can house sensitive electronics and sensors for the snowpack measurement tool within a ski pole handle of the device when not in use.

### RELATED APPLICATION DATA

This application claims the benefit of priority of U.S. Provisional Patent Application Ser. No. 62/183,785, filed Jun. 24, 2015, and titled Multifunction Snowpack Measurement Tool, which is incorporated by reference herein in its entirety.

### FIELD OF THE INVENTION

The present invention generally relates to the field of snowpack measurement tools. In particular, the present invention is directed to a multifunction snowpack measurement tool.

### BACKGROUND

Every year, hundreds of people around the world die in avalanches because they lack crucial information about the stability of the snowpack. Annual avalanche fatalities have increased by 220% over the past two decades, fueled by a rapidly growing interest in backcountry sports, now the fastest growing segment of the snow sports industry. Moreover, avalanche risk is not limited to recreationalists, but affects the military, researchers, search and rescue personnel, transportation authorities, and alpine mining operations alike.

Current approaches to avalanche safety are reactive. Beacons, probes, shovels, and avalanche airbags are all designed to help increase chances of survival after you've been trapped in an avalanche. With a fatality rate greater than 50% for those buried in an avalanche, these devices fail to address the real need--avoiding avalanches altogether. Today's manual snow pit methods to detect weak layers in the snow underfoot are highly error prone, time-consuming, subjective, and only provide information about conditions in one location. There is a significant need for a low-cost device that can increase the speed and accuracy with which snowpack profiles can be evaluated.

### SUMMARY OF THE DISCLOSURE

In one implementation, the present disclosure is directed to an apparatus for measuring snow structure. The apparatus includes a sensing unit configured to probe a layer of snow and sense at least one characteristic of the layer of snow; a handle pole including an elongate shaft and a handle, the shaft defining an inner lumen that is configured and dimensioned to receive the sensing unit; and a lower pole slidably disposed at least partially within the inner lumen of the elongate shaft; wherein the apparatus is designed and configured to be converted between a skiing configuration, wherein a portion of the sensing unit is disposed within the inner lumen of the elongate shaft, and a snowpack measurement configuration, wherein the handle pole is separated from the sensing unit and lower pole.

In another implementation, the present disclosure is directed to an apparatus for measuring snow structure. The apparatus includes a sensing unit configured to probe a layer of snow and sense at least one characteristic of the layer of snow; a handle pole including an elongate shaft and a handle, the handle having a contoured outer surface configured and dimensioned to function as a ski pole handle, the handle further defining an inner cavity that is configured and dimensioned to receive a portion of the sensing unit; and a lower pole having a first end and a second end, the first end having a ski pole tip and a basket and the second end slidably disposed at least partially within the elongate shaft; and wherein the apparatus is designed and configured to be converted between a skiing configuration, wherein a portion of the sensing unit is disposed within the inner cavity of the handle, and a snowpack measurement configuration, wherein the handle pole is separated from the sensing unit and lower pole.

In yet another implementation, the present disclosure is directed to a method of using a snowpack measurement tool. The method includes using the tool in a skiing configuration as a ski pole, the tool including a handle pole including a ski pole handle and a lower pole including a ski pole tip; separating the handle pole from the lower pole to expose a sensing unit that was housed in the handle pole while in the skiing configuration; probing a layer of snow with the sensing unit; and measuring at least one characteristic of the layer of snow with the sensing unit.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIGS. 1A-1D show one exemplary embodiment of a snowpack measurement tool in use;

FIG. 2 is a perspective view of a snowpack measurement tool;

FIGS. 3A-3C show a process for converting a snowpack measurement tool from a skiing configuration to a snowpack measurement probe configuration;

FIG. 4 is a cross-sectional view of a locking mechanism;

FIG. 5 is a cross-sectional view of a handle pole with a sensing unit disposed therein;

FIG. 6 is another view of a handle pole having a coupling mechanism;

FIG. 7 is a detail view of the coupling mechanism shown in FIG. 6;

FIG. 8 shows a handle pole with a coupler;

FIG. 9 is a cross-sectional view of a handle and sensing unit showing a magnetic sensor system;

FIG. 10 is a cross-sectional view of a handle and sensing unit showing a magnetic sensor system;

FIG. 11 is a flow chart showing a process of using a snowpack measurement tool in a skiing configuration and a snowpack measurement configuration; and

FIGS. 12A-12C illustrate a process for probing a snowpack with a snowpack measurement tool.

### DETAILED DESCRIPTION

The present disclosure includes multi-function snowpack measurement tools that combine snowpack measurement instruments with a skiing tool, such as a ski pole. Embodiments disclosed herein include multi-function integrated systems that can be quickly and easily converted from a skiing configuration to a measurement configuration, which increases the ease of transporting and using the tool. Snowpack measurement tools disclosed herein can perform multiple functions, thereby decreasing the amount of specialized gear that users must carry with them into the backcountry, which can be useful for minimizing weight and amount of gear required on expeditions.

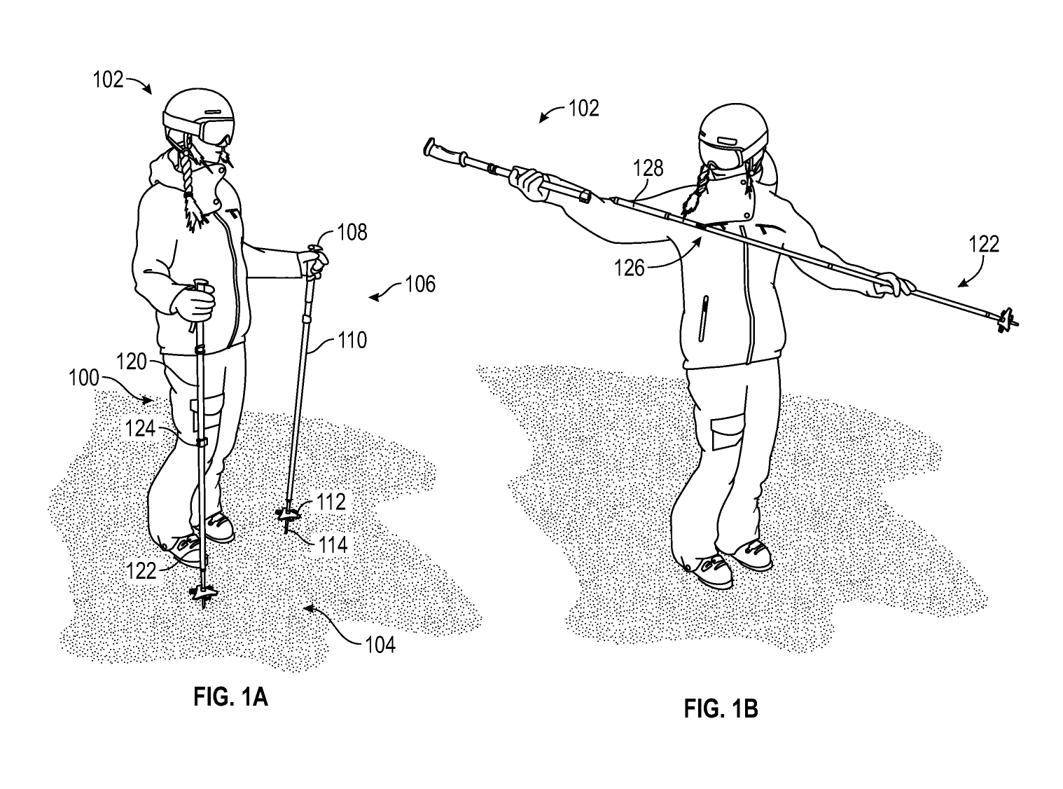

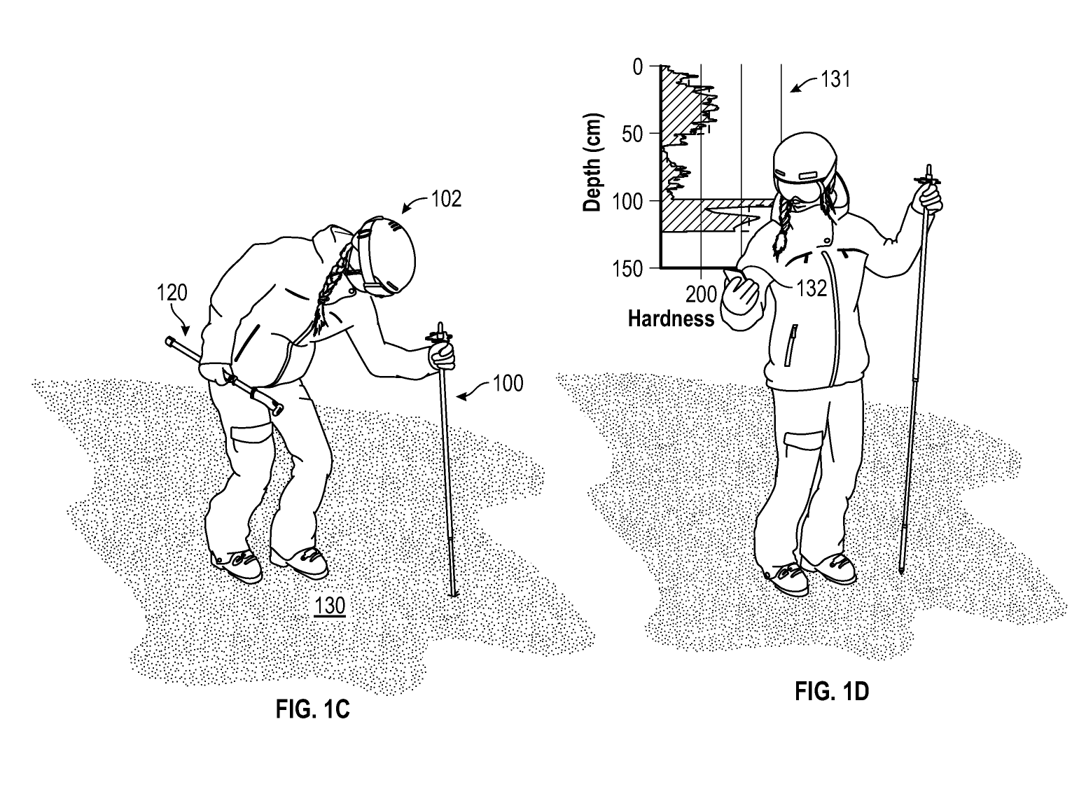

FIGS. 1A-1D show one exemplary embodiment of a snowpack measurement tool 100 in use. FIG. 1A shows a skier 102 with a pair of ski poles 104. In the illustrated example, ski pole 106 is a standard ski pole and may include a handle 108, a shaft 110, a basket 112, and a tip 114. Shaft 110 may have a fixed length, or may be adjustable, as is well known in the art. The other one in the pair of ski poles 104 is a snowpack measurement tool 100. FIG. 1 shows snowpack measurement tool 100 in a skiing configuration, where, from outward appearances, it can appear to be a standard ski pole. Illustrated snowpack measurement tool 100 includes a handle pole 120 and a lower pole 122, the handle pole and lower pole being slidably coupled by a locking mechanism 124 to allow for an overall length of snowpack measurement tool 100 to be adjusted while in the skiing configuration, as is commonly available with standard ski poles, such as standard ski pole 106.

FIG. 1B shows user 102 converting snowpack measurement tool 100 from the skiing configuration shown in FIG. 1A to a snowpack measurement probe configuration. As discussed more below, in the illustrated example, converting from the skiing configuration to the probe configuration may include unlocking locking mechanism 124 and removing handle pole 120 from lower pole 122, to expose a sensing unit pole 126, which includes a sensing unit 128 configured to probe a layer of snow and sense at least one characteristic of the layer of snow. As described more below, sensing unit pole 126 and sensing unit 128 may be configured to be disposed within handle pole 120 when snowpack measurement tool 100 is in the skiing configuration. As shown in FIG. 1C, with snowpack measurement tool 100 converted to the probe configuration, user 102 can probe snowpack 130 to measure one or more characteristics of the snowpack versus depth of penetration. In some examples, the one or more characteristics can include penetration resistance, snow layer temperature, snow grain size, and snow grain type, among others. Such data can be used to generate profiles of the one or more characteristics vs. depth. Examples of snowpack measurement tools that measure snowpack characteristics versus depth include U.S. patent application Ser. Nos. 14/063,973; 14/063,557; 14/063,649; 14/063,959, all four of which were filed on Oct. 25, 2013, as well as in U.S. patent application Ser. No. 14/473,769, filed on Aug. 29, 2014, all of which are incorporated by reference herein in their entireties. As discussed more below, sensing unit 128 may be configured to wirelessly transmit the measurement data 131 to, for example, a hand-held electronic device 132 for user 102 to review. User 102 may probe snowpack 103 in additional locations, and when complete, the user can convert snowpack measurement tool 100 back into the skiing configuration and use the snowpack measurement tool as a ski pole or hiking pole to travel to another location.

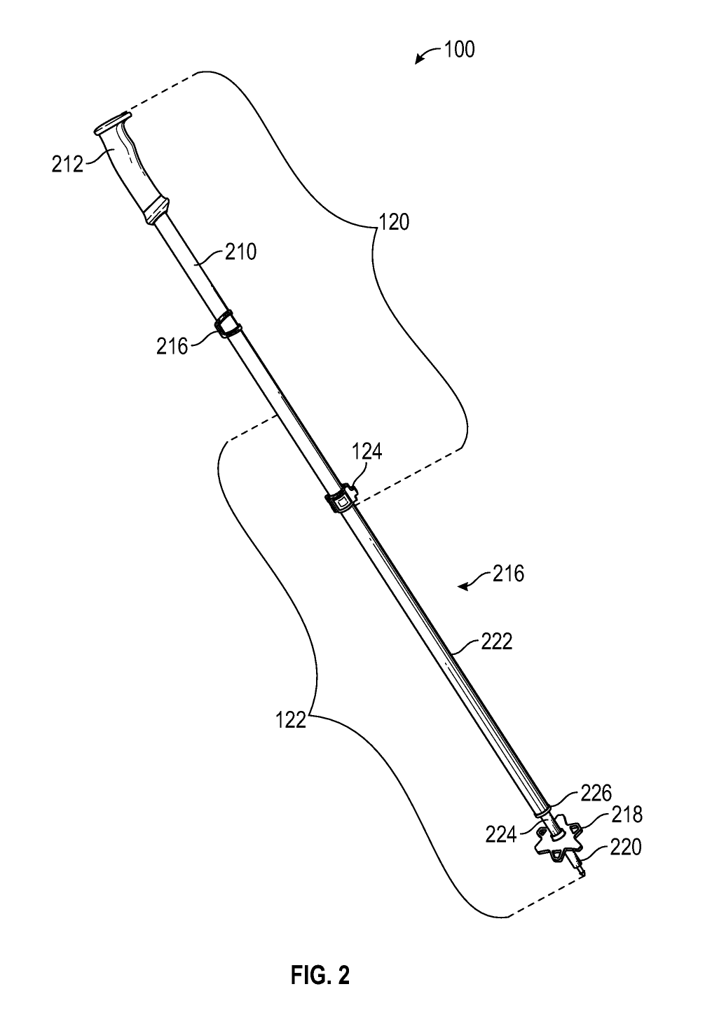

FIG. 2 is another view of snowpack measurement tool 100 in the skiing configuration, according to some embodiments. As shown, snowpack measurement tool 100 can include handle pole 120 and lower pole 122. According to some embodiments, the handle pole 120 and lower pole 122 can be configured to slide relative to one another along their corresponding respective longitudinal axes. At least part of each pole can comprise a hollow tube, and the hollow tubes for handle pole 120 and lower pole 122 can have different cross-sectional diameters such that a narrower tube can be disposed inside of a tube with a wider diameter. For example, lower pole 122 can have a smaller cross-sectional diameter than handle pole 120, and can be configured to insert within handle pole 120 such that it can slide up and down along both poles' longitudinal axis.

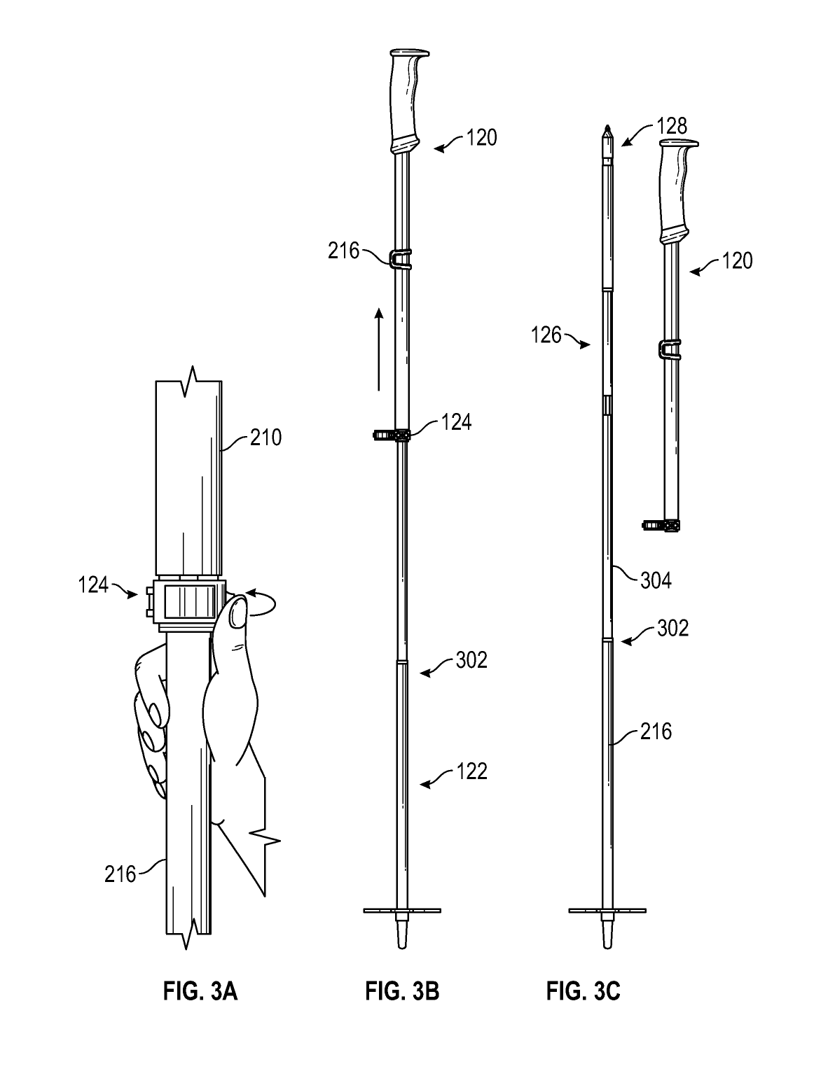

Handle pole 120 can include a handle pole shaft 210, a handle 212, locking mechanism 124 for releasably locking the handle pole to lower pole 122 and a coupling mechanism 216 for releasably coupling the handle pole to the sensing unit pole 126 (FIG. 1B). Lower pole 122 can include a lower pole shaft 216, a basket 218, and a tip 220. Lower pole shaft 216 may include a first larger diameter portion 222 and a second smaller-diameter portion 224, the first and second portions separated by a step 226. Having a stepped lower pole shaft 216 allows for sensing unit shaft 304 (FIG. 3C) to be fully inserted into the lower pole shaft, with an end of the sensing unit shaft proximate to and/or abutting step 226 when fully inserted. In some examples, an outer diameter of first portion 222 of lower pole shaft 216 may be substantially constant along the entire length of the first section of the lower pole shaft. In some examples, both lower pole shaft 216 and sensing unit shaft 304 (FIG. 3C) may have depth markings (not illustrated) along the length of the shafts to help a user gauge how far he or she has inserted the snowpack measurement tool into the snow when the tool is in a snowpack measurement configuration. Handle pole shaft 210 and lower pole shaft 216 can be made from steel, aluminum, carbon fiber, or any other material that can be formed into a tubular structure. In some embodiments, these shafts can be cylindrical in shape (e.g., with a circular cross-section). In other embodiments, these shafts can have elliptical cross-sections. Shafts with cross-sections having other shapes are also possible.

FIGS. 3A-3C illustrates the process for converting snowpack measurement tool 100 from the skiing configuration to the snowpack measurement probe configuration. FIG. 3A shows how a user can release locking mechanism 124, which can enable handle pole shaft 210 to slide freely relative to lower pole shaft 216. Once locking mechanism 124 is opened, FIG. 3B shows how the user can pull handle pole 120 upwards. In the illustrated example, handle pole 120 and sensing unit pole 126 are held together by coupling mechanism 216, such that when the handle pole is slid away from lower pole 122, the sensing unit pole is also slid away from the lower pole, thereby moving the sensing unit pole from an inserted position within the lower pole, to an extended position. As the user continues to pull handle pole 120 upwards, eventually a locking mechanism 302 will engage, thereby locking sensing unit pole 120 relative to lower pole 122 in an extended position, and preventing the handle pole 120 from moving farther away from lower pole 122. The user can then open coupling mechanism 216, thereby decoupling handle pole 120 from sensing unit pole 126, allowing the handle pole to be completely removed, as shown in FIG. 3C. As shown in FIG. 3C, sensing unit pole 126 includes sensing unit shaft 304, which, in the illustrated example, has a smaller diameter than lower pole shaft 216 and a complementary cross-sectional shape such that the sensing unit shaft and lower pole shaft can slide relative to one another along their longitudinal axes between an inserted and extended position. As with handle pole shaft 210 and lower pole shaft 216, sensing unit shaft 304 can be made from steel, aluminum, carbon fiber, or any other material that can be formed into a tubular structure. In some embodiments, these shafts can be cylindrical in shape (e.g., with a circular cross-section). In other embodiments, these shafts can have elliptical cross-sections. Shafts with cross-sections having other shapes are also possible. Sensing unit 128 can be located at an end of sensing unit pole 126 and can house the device electronics system and critical measurement sensors used to implement a snowpack measurement tool for measuring one or more characteristics of a snowpack when inserted therethrough. Examples of sensors and associated electronics for measuring characteristics of a snowpack that can be incorporated into sensing unit 128 may be found in U.S. patent application Ser. Nos. 14/063,973; 14/063,557; 14/063,649; 14/063,959, all four of which were filed on Oct. 25, 2013, as well as in U.S. patent application Ser. No. 14/473,769, filed on Aug. 29, 2014, which are incorporated by reference herein in their entireties.

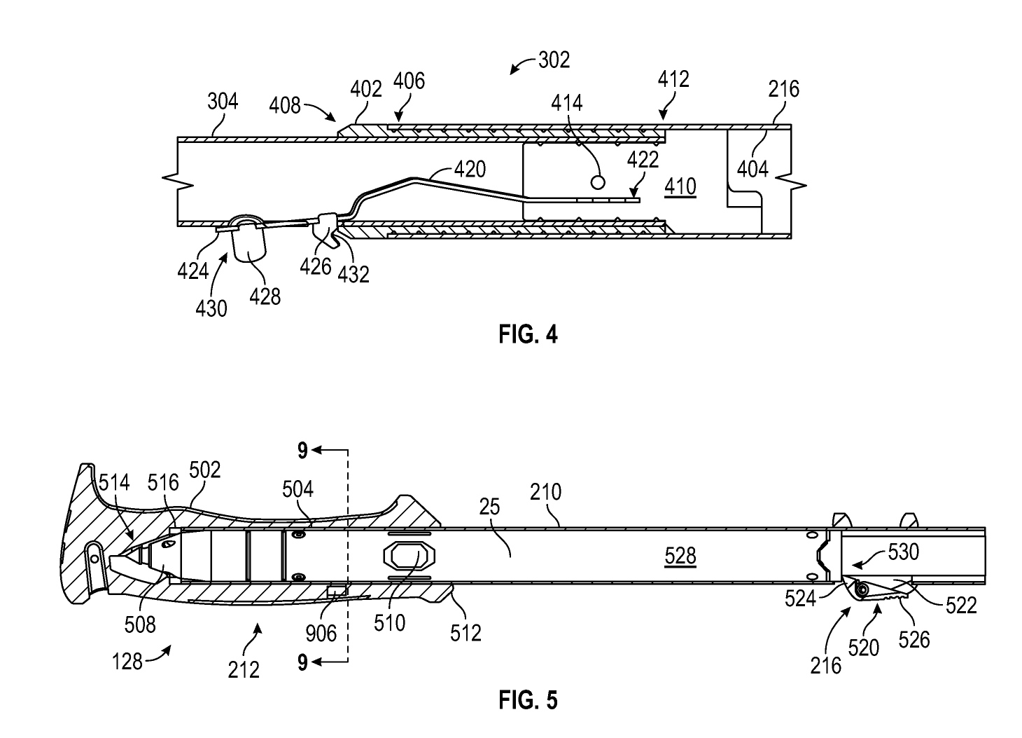

FIG. 4 is a cross-sectional view of an interface between sensing unit pole 126 and lower pole 122, showing locking mechanism 302 in greater detail. As described above, locking mechanism 302 locks sensing unit shaft 304 in an extended position relative to lower pole shaft 216. Exemplary lower pole shaft includes sheath 402 fixed to inner wall 404 of lower pole shaft 216. Sheath 402 may include a step 406 abutting an end of the lower pole shaft, and a tapered end 408. Sensing unit shaft 304 can include a plug 410 fixed to an end of the sensing unit shaft. Plug 410 includes a step 412 sized to abut an end of sheath 402, such that the sheath and the plug act to stop sensing unit shaft 304 from being completely removed from lower pole shaft 216. Plug 410 is fixed to sensing unit shaft 304 by a rod 414 fixed to the sensing unit shaft and that extends through the plug. Exemplary locking mechanism 302 includes a resiliently-biased spring arm 420 having a first end 422 fixed within plug 410 and a second end 424. A catch 426 and button 428 are fixed to spring arm 420 adjacent one or more openings 430 in sensing unit shaft 304. Spring arm 420 is biased in a radially-outward direction, such that when sensing unit shaft 304 is extended to a point where openings 430 are not covered by lower pole shaft, catch 426 and button 428 may extend though the openings and beyond the wall of the sensing unit shaft, allowing the catch to engage tapered end 408 of sheath 402, thereby locking the sensing unit shaft in place. Exemplary catch 426 has a complementary shape to tapered end 408 of sheath 402 in the form of an angled recess 432 that, when engaged with the sheath, prevents lateral forces exerted on locking mechanism 302, such as forces exerted by layers of snow during probe insertion, from pushing button 428 and catch 426 radially inward and disengaging the locking mechanism. In the illustrated example, locking mechanism 302 also includes button 428 for disengaging the locking mechanism. Button 428 can be larger and have a smoother outer surface than catch 426, thereby making it easier for a user to unlock locking mechanism 302, such as when the user is wearing gloves. Button 428 also eliminates the need to directly depress catch 426, which could result in a user's finger or glove being pinched between angled recess 432 and sheath 402.

FIG. 5 is a cross-sectional view of handle pole 120 showing sensing unit pole 126 inserted therein, e.g., when the snowpack measurement tool 100 is in the skiing configuration. As shown in FIG. 5, handle 212 can have a contoured outer surface 502 that is essentially the same as a standard ski pole handle, including an ergonomic grip that contours to the shape of a user's closed hand around the handle. Unlike standard ski pole handles, handle 212 includes an inner cavity 504 that is sized and configured to receive sensing unit 128. Handle pole shaft 210 can similarly include an inner wall defining an inner lumen 506 sized and configured to slidingly receive sensing unit 128 and sensing unit shaft 304. By housing sensing unit 128 within handle 212, the sensitive electronics in sensing unit 128 can be more adequately protected while in the skiing configuration, with the sensing unit at the opposite end of the tool 100 from the ski tip 220 (FIG. 2), and the extra materials in handle 212 providing additional shock protection. Housing sensing unit 128 within handle 212 can also minimize the impact of the additional weight associated with sensing unit 128 by minimizing the moment arm associated with the weight of the sensing unit. In some examples, standard ski pole 106 (FIG. 1A) may be weighted to approximate the weight and moment of inertia of snowpack measurement tool 100 in the skiing configuration so that the pair of ski poles 104 (FIG. 1) will have a balanced weight during skiing. For example, a weight may be added to one or both of handle 108 and shaft 110 (FIG. 1A). In other examples, handle 108 and shaft 110 may include a compartment (not illustrated) for storing additional items, such as one or more tools which can help make the weight of standard ski pole be closer to the weight of snowpack measurement tool 100.

Exemplary sensing unit 128 includes a tapered tip 508 that is configured to penetrate snowpack layers and that includes a force sensor configured to sense a resistance to penetration. Sensing unit 128 may also include optical flow sensors 510 for sensing a rate of insertion into a snowpack, which may be used by an internal processor (not shown) to determine a depth of insertion. Depth of insertion and force measurements may then be used to determine a profile of resistance versus depth for the snowpack, which can be used to determine risk of avalanche. As described above, sensing unit 128 may also be configured to measure other characteristics of the snowpack. As shown in FIG. 5, when sensing unit 128 is fully inserted within handle 212, the optical sensors 510 are located within the handle rather than distal of distal end 512 of the handle, to thereby provide additional protection for the sensors. Inner cavity 504 includes a tapered proximal end 514 sized and configured to receive tapered tip 508 and a resilient member 516 configured to abut a portion of the tip when inserted therein. Handle pole 120 includes coupling mechanism 216, which is shown in cross-section in FIG. 5. Coupling mechanism includes a spring-biased lever 520 located in an opening 522 of handle pole shaft 210. Lever 520 includes a catch 524 and an extension 526. Catch 524 is biased radially inward such that when sensing unit pole 126 is fully inserted into handle pole 120, the catch automatically slides along outer wall 528 of sensing unit 128 and engages a step 530 in the outer wall of the sensing unit, thereby preventing the sensing unit from being removed from the handle pole until a user depresses extension 526 and disengages the catch from the step. The illustrated sensing unit 128 and sensing unit shaft 304 have a circular cross-section and are configured to freely rotate within handle pole 120 when locking mechanism 124 is open. Step 530 similarly has a circular cross-section and extends around the circumference of the sensing unit and sensing unit shaft, which allows lever 520 to engage the step when the sensing unit 128 is in any rotational position with respect to handle pole 120. Such an arrangement improves ease of use by not requiring the user to rotationally align handle pole 120 with sensing unit 128 when re-inserting the sensing unit into the handle pole.

Handle pole 120 and sensing unit pole 126 are configured and dimensioned so that they are tightly and resiliently coupled when in the skiing configuration. In the illustrated example, the lengths and positions of components in the handle pole 120 and sensing unit pole 126 are selected such that tapered tip 508 will come into contact with and begin to compress resilient member 516 before lever 520 engages step 530. Thus, one or more resilient members may be located in handle inner cavity 504 that are configured to bias sensing unit 128 against lever 520 for a secure connection that resists relative axial movement.

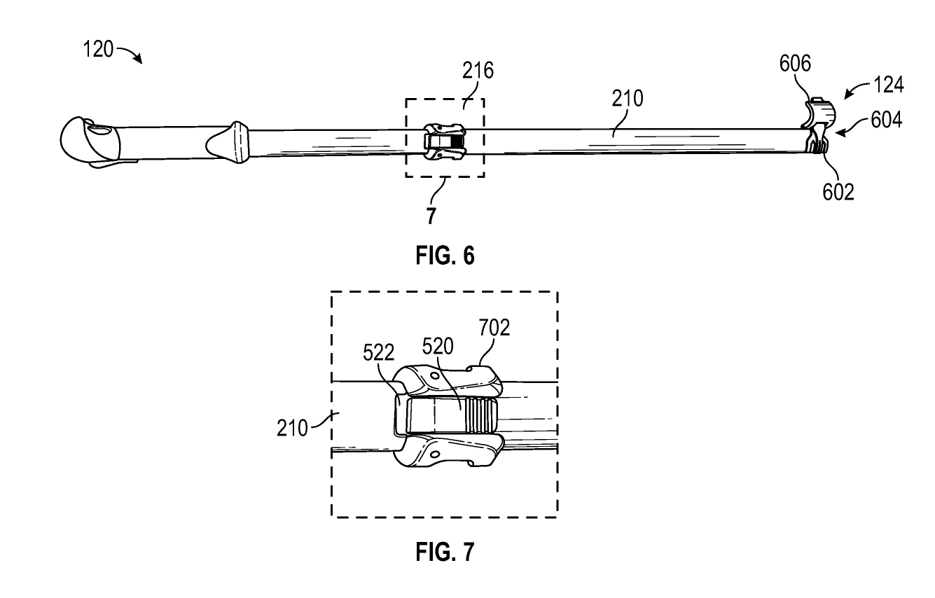

FIGS. 6 and 7 show additional views of sensing unit pole 120 and coupling mechanism 216. In the illustrated example, locking mechanism 124 includes a circumferential band 602 disposed around a distal end 604 of handle pole shaft 210. A curved lever 606 pivotally coupled to band 602 is pivotable between an open position, shown in FIG. 6, where band 602 has a larger circumference, to a closed position, where curved lever 606 is positioned against the outer surface of handle pole shaft 210, which causes the circumference of band 602 to decrease. Such a reduction in circumference reduces a circumference of distal end 604 of handle pole shaft 210, which causes the handle pole shaft to lock to the lower pole shaft 216 when the lower pole shaft is inserted therein. In other examples, other locking mechanisms, such as twist lock mechanisms or other lever-based shaft locking mechanisms may be used. As shown in FIGS. 6 and 7, coupling mechanism lever 520 is pivotally mounted in opening 522 of shaft 210 by a housing 702 disposed around a portion of a circumference of an outer wall of shaft 210 and that defines a longitudinal space that lever 520 is mounted in.

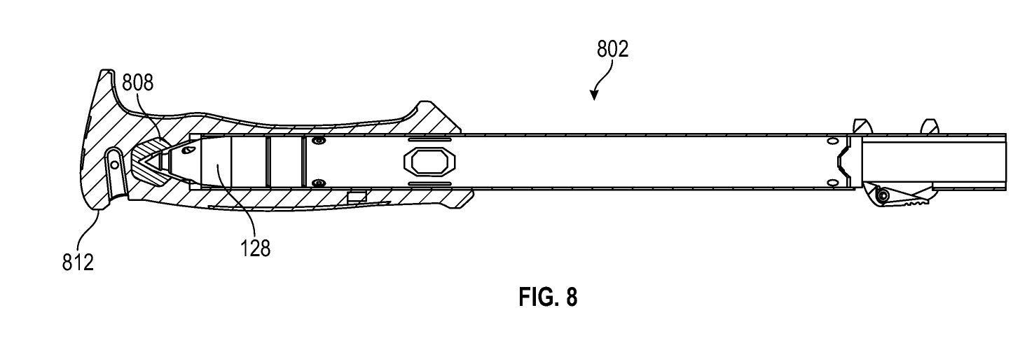

FIG. 8 shows another embodiment of a handle pole 802. Handle pole 802 can include an alternative coupler 808 for coupling the handle pole to sensing unit 128. Coupler 808 may be used instead of or in addition to coupling mechanism 216. Exemplary coupler 808 is a flexible, resilient, mechanical catch that may be configured to couple to one or more features on an outer surface of sensing unit 128 when the sensing unit is fully inserted into handle 812, providing, for example, a tactile and/or audible “click” when engaged. Coupler 808 may be configured to hold sensing unit 128 up until a predetermined pulling force, and then release the sensing unit. When handle pole 802 is pulled from lower pole 122 (FIG. 2), coupler 808 may initially hold sensing unit 128 within handle 812 until sensing unit pole 126 reaches a stop within lower pole 122, such as sheath 402 (FIG. 4). After reaching the stop, as the user continues to pull on handle pole 802, once a predetermined pulling force is exceeded, coupler 808 will release sensing unit 128, thereby allowing handle pole 802 to be removed and the sensing unit exposed for probing snowpack.

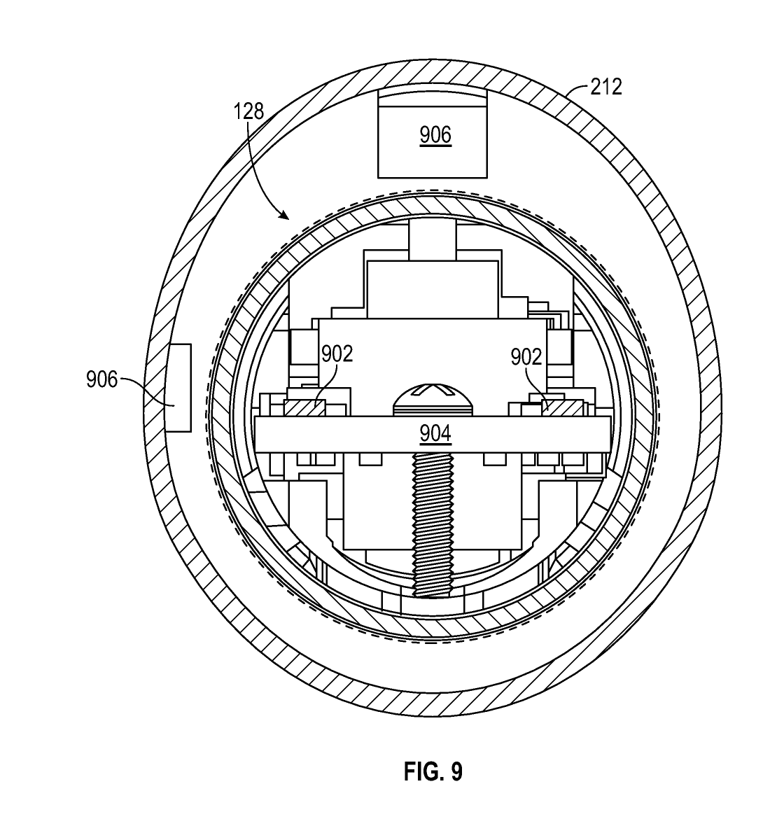

In some embodiments, the snowpack measurement sensors and electronics disposed in sensing unit 128 can be configured to automatically turn on when the sensing unit detects that handle pole 120 has been removed. FIG. 9 is a cross-sectional view of handle 212 and sensing unit 128 when the sensing unit is disposed within in the handle, with the sensing unit being the portion in FIG. 9 inside of the circle formed by broken line 900. In the illustrated example, two sensors 902 are mounted on a printed circuit board 904 within sensing unit 128. Exemplary sensors 902 may be configured to sense the presence or absence of a magnetic field generated by magnets 906 disposed within handle 212 such that, when handle pole 120 is removed from sensing unit, sensors 902 will sense the change in magnetic field and generate a signal that causes sensing unit 128 to power on, for example, to a standby mode. Similarly, when sensing unit 128 is re-inserted into handle pole 120, sensors 902 may generate a signal that causes sensing unit to power off. Two non-limiting examples of sensors 902 are a hall-effect sensor and a reed-switch sensor. In the illustrated example, both of sensors 902 are the same, e.g., both hall-effect. Magnets 906 are circumferentially spaced within handle 212 by an angular distance of less than or greater than approximately 180 degrees, here, approximately 90 degrees. In some examples, sensors 902 have a preferred orientation with respect to the magnetic field generated by magnets 906 for sensing the magnetic field. For example, the sensors may be configured to sense a magnetic field having a first orientation to the sensor and have little or no ability to sense a magnetic field in a second orientation that is approximately 90 degrees in relation to the first orientation. By positioning two magnets 906 at two circumferential positions other than 180 degrees, sensors 902 can detect the presence or absence of the magnetic fields generated by the magnets when the handle is in any circumferential orientation with respect to sensing unit 128. Such an arrangement allows for the sensing unit pole 126 and handle pole 120 to freely rotate relative to one another while still ensuring sensors 902 detect when the handle pole is removed. In another embodiment, two magnets and only one sensor 902 may be used.

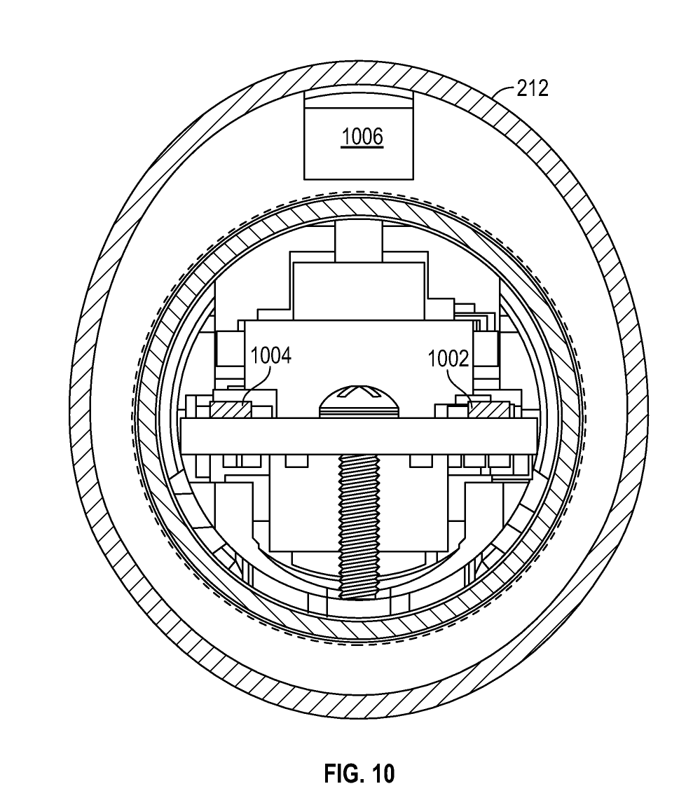

FIG. 10 shows another embodiment that includes a magnet 1006 at only one circumferential location, and first and second sensors 1002, 1004 that are two different types of sensors that detect magnetic fields at different orientations. In some embodiments, such as the embodiment shown in FIG. 10, only one magnet may be used due to space limitations within the handle and/or to reduce weight. In one example, sensor 1002 may be a hall-effect sensor and sensor 1004 may be a reed switch. Exemplary hall effect sensor 1002 has a first preferred orientation with respect to magnet 1006 and reed switch 1004 has a second preferred orientation with respect to the magnet. For example, in the orientation shown in FIG. 10, hall effect sensor 1002 may be active and reed switch 1004 may be inactive. And when handle 212 and magnet 1006 are rotated +/−90 degrees relative to sensing unit 128 from the position shown in FIG. 10, reed switch 1004 may be active and hall effect sensor 1002 inactive. For example, FIG. 10 shows magnet 1006 at a 12 o'clock position. If magnet 1006 is moved to a three o'clock or 9 o'clock position while sensing unit 128 remains stationary, hall effect sensor may no longer sense the magnet while reed switch 1004 may begin to sense the magnet. By having two different sensor types with different preferred sensed magnetic field orientations, sensors 1002 and 1004 can detect the removal and insertion of sensing unit 128 from handle pole 120 when the handle pole and magnet 1006 are at any rotational position with respect to sensors 1002, 1004. Thus, sensing unit 128 may include at least one first magnetic sensor and at least one second magnetic sensor, both sensors configured to sense a position of handle pole 120 with respect to sensing unit 128, wherein the first and second magnetic sensors have different preferred sensed magnetic field orientations, thereby enabling detection of the removal and re-insertion of the sensing unit from the handle pole when the handle pole is at any rotational position with respect to the sensing unit.

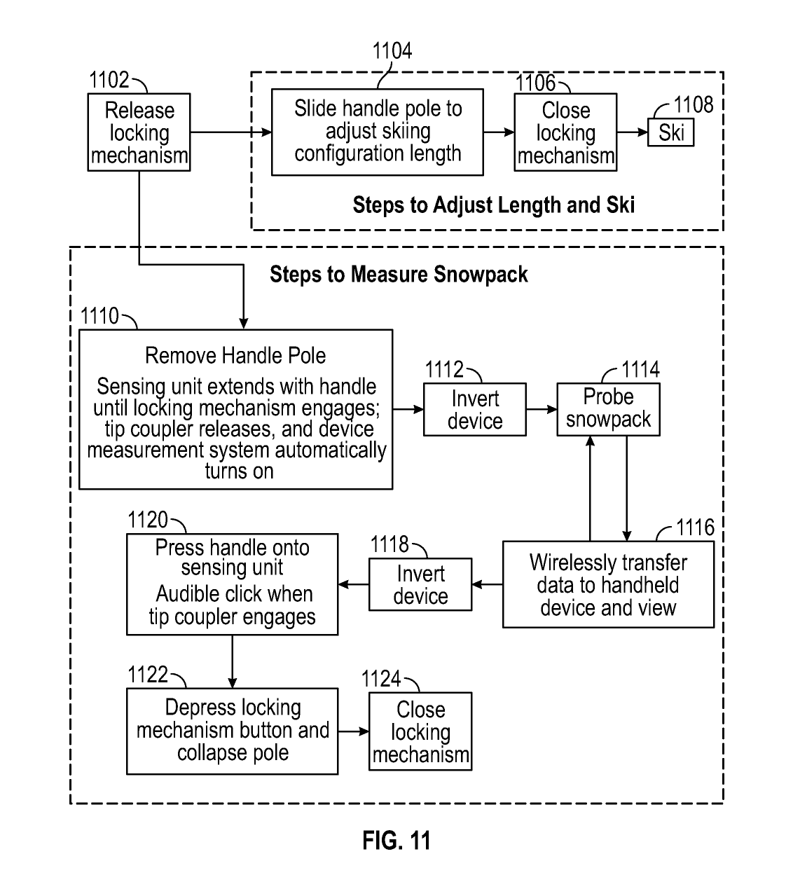

FIG. 11 is a flow chart showing a process of using a snowpack measurement tool in a skiing configuration and a snowpack measurement configuration. The exemplary process for adjusting the length of the tool while in a skiing configuration begins at step 1102, where a locking mechanism, e.g., locking mechanism 124 is released. At step 1104, the user can slide the handle pole 120 to adjust the skiing configuration length. When the device is at the desired skiing configuration length, at step 1106 the user can close the locking mechanism 124 and at step 1108 the device is now ready for use as a ski pole.

The process for converting the device from a skiing configuration into a snowpack measurement configuration also begins at step 1102, where the locking mechanism 124 is released. At step 1110, the user can remove the handle pole by pulling the handle pole upward, causing the sensing unit to extend with the handle until locking mechanism 302 engages. In the embodiment shown in FIGS. 2, 5, 6, and 7, the user can then depress latch 520 of coupling mechanism 216 to release the handle pole from the sensing unit pole. In the embodiment shown in FIG. 8, when locking mechanism 302 engages, as the user continues to pull on the handle pole, the sensing unit tip coupler 808 releases when a predetermined pulling force is exceeded, and the handle pole can then be completely removed from the device. In some embodiments, the snowpack measurement sensors and electronics disposed in sensing unit 128 can be configured to automatically turn on when the sensing unit detects that the handle pole has been removed, such as with the magnet-based sensor system described above.

At step 1112, the user can invert the device, and at step 1114, the user can probe the snowpack. At step 1116, the data gathered by the sensing unit during the probing process are sent to a user's handheld device for viewing and storage. The probing of the snowpack can be conducted multiple times either on the same patch of snow, or on different patches of snow to gather multiple readings. In some embodiments, multiple readings can be averaged together using the techniques disclosed in at least paragraphs 124-129 and FIGS. 21A, 21B, and 22 of U.S. patent application Ser. No. 14/473,769, filed on Aug. 29, 2014, which is incorporated by reference herein in its entirety.

Once the user has completed probing the snowpack, the user can convert the device from the snowpack measurement configuration back to the skiing configuration. At step 1118, the user can invert the device. At step 1120, the user can slide handle pole 120 back over sensing unit 128 and sensing unit pole 126. Sensing unit 128 and handle pole 120 can be re-coupled by pressing the sensing unit into the handle pole until mechanically coupled, e.g., by coupling mechanism 216 (FIG. 2) or coupler 808 (FIG. 8). In some embodiments, the sensors and electronics in sensing unit 128 can be configured to automatically turn off when the sensing unit detects handle pole 120, e.g, the presence of magnets in the handle pole. At step 1122, the user can depress the locking mechanism 302 (FIGS. 3C and 4) and collapse sensing unit pole 126 back into lower pole 122. When the device is at the correct length, the user can close locking mechanism 124. The device is now back in the skiing configuration.

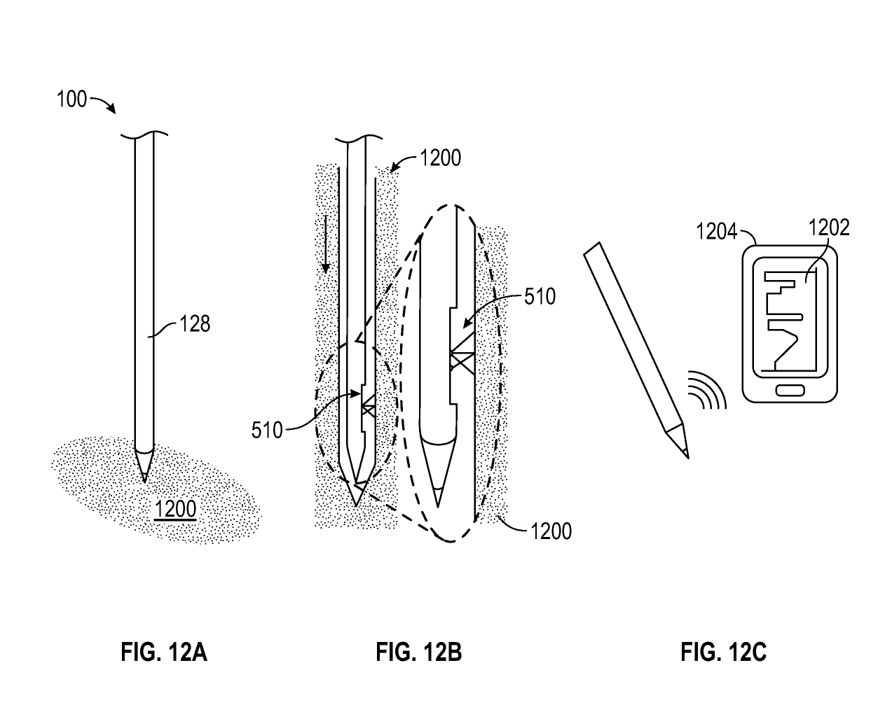

FIGS. 12A-12C illustrate a process for probing a snowpack with snowpack measurement tool 100. A snowpack can have multiple layers of snow. As shown in FIG. 12A, the user can push sensing unit 128 of snowpack measurement tool 100 (while in the snowpack measurement configuration) into snowpack 1200. Force sensors disposed in sensing unit 128 can measure the force required to push through each layer of snow. Examples of force sensors, as well as associated components that support the operation of force sensors and/or protect force sensors from damage, are disclosed in at least paragraphs 77-93 and FIGS. 7, 8A, 8B, 8C, 9, 10, and 11 of U.S. patent application Ser. No. 14/063,973 filed on Oct. 25, 2013. To the extent not already incorporated, these sections are specifically incorporated herein by reference.

As shown in FIG. 12B, the sensing unit 128 can also comprise an optical flow sensor 510 configured to face radially outward into the snow 1200. The optical flow sensor can be configured to take images of snow layers as the sensing unit 128 penetrates deeper into the snow, and to calculate based on these images a displacement, and hence penetration depth, of sensing unit 128. Examples of optical flow sensors and methods for using optical flow sensors to measure penetration depth are disclosed in at least paragraphs 57, 61-64, 110, and 114, and FIGS. 2B and 17 of U.S. patent application Ser. No. 14/063,973 filed on Oct. 25, 2013. To the extent not already incorporated, these sections are specifically incorporated herein by reference.

As shown in FIG. 12C, the combination of force data sensed by the force sensors and the penetration depth sensed by the optical flow sensors 510 can be combined to generate a profile 1202 of snow hardness or resistance to penetration vs. depth. This data can be sent from snowpack measurement tool 100 to a user's mobile device 1204, such as a smartphone. The smartphone can then display the data in a graph with force on the x-axis and depth on the y-axis. Examples of (i) resistance vs. depth profiles, (ii) methods, apparatus and systems for generating such profiles, and (iii) methods, apparatus and systems for sending such profiles to a mobile device are disclosed in at least paragraphs 101-123, and FIGS. 13, 14, 15, 16, 17, 18, and 19 of U.S. patent application Ser. No. 14/063,973 filed on Oct. 25, 2013. To the extent not already incorporated, these sections are specifically incorporated herein by reference.

Other configurations not illustrated in the above figures are also possible. For example, instead of housing a sensing unit within a ski pole handle, the sensing unit can also be provided as a separate hardware device that can be carried separate from a ski pole, and then clipped onto an end of the ski pole as needed for probing snow. In some embodiments, the basket of a ski pole can be removed before clipping a sensing unit onto the end of the pole, or an additional extender pole can be installed between the sensing unit and lower pole. In other embodiments, a standalone sensing unit can also be configured to be built into or clipped onto any suitable piece of back-country equipment, including without limitation, avalanche probes, trekking poles, skis, ice axes, avalanche shovel handles, tent poles, or an extendable pole.

While the above disclosure shows embodiments with a coupling mechanism 216 (FIG. 2) or coupler 808 (FIG. 8), some embodiments may not include either. Instead, in those embodiments, handle pole 120 can be configured to freely detach from sensing unit 128. Also, as noted above, in addition to using measurements from a force sensor to generate a profile of penetration resistance vs. depth, the disclosed device can also be configured to perform other snowpack measurements. For example, the disclosed device can be configured to measure snow layer temperature, snow grain size, and/or snow grain type relative to depth, and to generate a profile of temperature, snow grain size, or snow grain type relative to depth. Examples of snowpack measurement tools that measure temperature vs. depth are disclosed throughout U.S. patent application Ser. No. 14/063,557 filed Oct. 25, 2013, and in particular at paragraphs 5-23, 55-56, 76-77, 93, and 102-113. Examples of snowpack measurement tools that measure snow grain size relative to depth are disclosed throughout U.S. patent application Ser. No. 14/063,649 filed Oct. 25, 2013, and in particular at paragraphs 5-21, 53, and 100-111. To the extent not already incorporated, all of these sections are specifically incorporated herein by reference.

The foregoing has been a detailed description of illustrative embodiments of the invention. It is noted that in the present specification and claims appended hereto, conjunctive language such as is used in the phrases “at least one of X, Y and Z” and “one or more of X, Y, and Z,” unless specifically stated or indicated otherwise, shall be taken to mean that each item in the conjunctive list can be present in any number exclusive of every other item in the list or in any number in combination with any or all other item(s) in the conjunctive list, each of which may also be present in any number. Applying this general rule, the conjunctive phrases in the foregoing examples in which the conjunctive list consists of X, Y, and Z shall each encompass: one or more of X; one or more of Y; one or more of Z; one or more of X and one or more of Y; one or more of Y and one or more of Z; one or more of X and one or more of Z; and one or more of X, one or more of Y and one or more of Z.

Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve aspects of the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. An apparatus for measuring snow structure comprising:
a sensing unit configured to probe a layer of snow and sense at least one characteristic of the layer of snow;
a handle pole including an elongate shaft and a handle, the shaft defining an inner lumen that is configured and dimensioned to receive the sensing unit; and
a lower pole slidably disposed at least partially within the inner lumen of the elongate shaft;
wherein the apparatus is designed and configured to be converted between a skiing configuration, wherein a portion of the sensing unit is disposed within the inner lumen of the elongate shaft, and a snowpack measurement configuration, wherein the handle pole is separated from the sensing unit and lower pole.

2. An apparatus according to claim 1, wherein the lower pole has an inner wall defining an inner lumen, the apparatus further comprising a sensing unit pole having a first end and a second end, the sensing unit located at the first end, the sensing unit pole being slidably disposed within the inner lumen of the lower pole and adjustable between an inserted position and extended position.

3. An apparatus according to claim 2, wherein the lower pole includes a stepped shaft including a larger diameter portion and a smaller diameter portion and a step therebetween, wherein the second end of the sensing unit pole abuts the step when the sensing unit pole is in the inserted position.

4. An apparatus according to claim 2, wherein the handle pole further includes a coupling mechanism for releasably coupling the handle pole to the sensing unit, the handle pole being configured to pull the sensing unit pole towards the extended position when the handle pole is slid away from the lower pole and the coupling mechanism is engaged.

5. An apparatus according to claim 4, wherein the coupling mechanism includes a spring-biased lever configured to engage the sensing unit pole.

6. An apparatus according to claim 5, wherein the coupling mechanism is configured to engage a step in the sensing unit pole that extends around the circumference of the sensing unit pole.

7. An apparatus according to claim 4, wherein the coupling mechanism includes a resiliently-biased catch configured to couple to the sensing unit and to release after a pulling force on the handle pole has exceeded a predetermined value.

8. An apparatus according to claim 4, wherein the handle pole further includes a locking mechanism for releasably locking the handle pole and lower pole and for adjusting the length of the apparatus when the apparatus is in the ski pole configuration.

9. An apparatus according to claim 2, wherein the lower pole has a first end and a second end, the apparatus further including a locking mechanism for releasably locking the sensing unit pole to the lower pole when the sensing unit pole is in the extended position, the locking mechanism including a catch having a complementary shape to the first end of the lower pole for engaging the first end of the lower pole and resisting disengagement due to lateral forces acting on the catch.

10. An apparatus according to claim 9, wherein the locking mechanism further includes a spring arm and a button for disengaging the locking mechanism, the catch and the button being located on the spring arm.

11. An apparatus for measuring snow structure comprising:
a sensing unit configured to probe a layer of snow and sense at least one characteristic of the layer of snow;
a handle pole including an elongate shaft and a handle, the handle having a contoured outer surface configured and dimensioned to function as a ski pole handle, the handle further defining an inner cavity that is configured and dimensioned to receive a portion of the sensing unit; and
a lower pole having a first end and a second end, the first end having a ski pole tip and a basket and the second end slidably disposed at least partially within the elongate shaft;
wherein the apparatus is designed and configured to be converted between a skiing configuration, wherein a portion of the sensing unit is disposed within the inner cavity of the handle, and a snowpack measurement configuration, wherein the handle pole is separated from the sensing unit and lower pole.

12. An apparatus according to claim 11, wherein the sensing unit includes at least one sensor configured to detect when the handle pole is separated from the sensing unit, the sensing unit configured to perform at least one of (1) automatically turn on when the sensor detects the handle pole has been separated from the sensing unit or (2) automatically turn off when the sensor detects the sensing unit is inserted into the handle pole.

13. An apparatus according to claim 12, wherein the handle further includes at least one magnet, the sensor being configured to sense a presence of a magnetic field generated by the magnet.

14. An apparatus according to claim 13, wherein the at least one sensor includes a first magnetic sensor and a second magnetic sensor, the first and second magnetic sensors having different preferred sensed magnetic field orientations, the first magnetic sensor being positioned to detect the at least one magnet at different rotational positions with respect to the sensing unit than the second magnetic sensor.

15. An apparatus according to claim 13, wherein the at least one sensor includes a hall effect sensor and a reed switch.

16. An apparatus according to claim 12, wherein the lower pole has an inner wall defining an inner lumen, the apparatus further comprising a sensing unit pole having a first end and a second end, the sensing unit located at the first end, the sensing unit pole being slidably disposed within the inner lumen of the lower pole and adjustable between an inserted position and extended position.

17. A method of using a snowpack measurement tool, comprising:
using the tool in a skiing configuration as a ski pole, the tool including a handle pole including a ski pole handle and a lower pole including a ski pole tip;
separating the handle pole from the lower pole to expose a sensing unit that was housed in the handle pole while in the skiing configuration;
probing a layer of snow with the sensing unit; and
measuring at least one characteristic of the layer of snow with the sensing unit.

18. A method according to claim 17, wherein the separating step includes sliding the handle pole away from the lower pole, the sliding causing the sensing unit to extend from the lower pole, the separating step further including uncoupling the handle pole from the sensing unit.

19. A method according to claim 17, further including wirelessly transmitting measurement data to a handheld mobile device, the measurement data including snow characteristic versus snow depth profiles.

20. A method according to claim 17, wherein the using the tool in a skiing configuration includes adjusting a height of the tool by sliding the handle pole relative to the lower pole, wherein the sensing unit moves with the handle pole during the adjusting.
